(19) United States
(12) Patent Application Publication
(10) Pub. No.: US 2004/0108642 A1
(43) Pub. Date: Jun. 10, 2004

(54) Saddle stitch finishing line having a device for forming a square back book

(76) Inventors: Robert Stolz, Downers Grove, IL (US); David G. Sharpe, Harrisonburg, VA (US); Glenn G. Johnson, Oak Park, IL (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/309,614

(22) Filed: Dec. 4, 2002

(51) Int. Cl. B42B 2/02

(52) U.S. Cl. 270/52.18

(57) ABSTRACT

A finishing line for forming a square back saddle stitch book. A conveyor is arranged to receive the book and to convey the book along a finishing path to a squaring station. A book clamp is disposed on opposite sides of the path and is arranged to clamp the book at a point generally adjacent to the spine. A squaring member includes a first portion transitioning toward a second portion, the second portion disposed generally in the path and is positioned to contact and flatten the spine of a book proceeding along the path.

### FIELD OF THE INVENTION

The present invention relates to saddle stitch finishing lines and, more specifically, to a saddle stitch finishing line having a device for forming a square back book from the saddle stitch book.

### BACKGROUND OF THE INVENTION

In printing and binding operations, books, pamphlets, large circulation periodicals, and other products may be formed from a collection of forms or signatures that have been bound together into what is commonly referred to as a book. The books may be bound in a number of known manners, such as, for example, perfect binding or saddle stitch binding.

Perfect binding is a method in which an adhesive is used to bind the pages or signatures of the publication to a backbone. In perfect binding operations, which is most commonly found on books and periodicals, the backbone of the finished product is rectangular. In many applications, and for a variety of reasons, some end users prefer perfect bound books over books bound using other methods.

Another binding method is saddle stitch binding. In saddle stitch binding, the signatures are folded along a spine. Each successive signature is inserted into the previous signature(s) with the spine nested into the spine of the previous signature(s). The signatures are then stitched to each other through spine along the fold. Saddle stitch binding also offers distinct advantages is in some applications, and thus is preferred for a number of known uses. However, although many end users prefer the square back book produced by perfect binding operations, the spine of a saddle stitched book typically is pointed or rounded.

### BRIEF DESCRIPTION OF THE DRAWINGS

FIG. 1 is a fragmentary schematic view in perspective of a saddle stitch finishing line assembled according to the teachings of the present invention to include a squaring station;

FIG. 2 is a an end view of a plurality of saddle stitched books assembled on a conventional saddle stitch binding line according to the prior art;

FIG. 3 is an end view of a plurality saddle stitch books assembled according to the teachings of the present invention;

FIG. 4 is a perspective view of a saddle stitched book oriented with its spine pointed downward;

FIG. 5 is an elevational view taken along line 5-5 of FIG. 4;

FIG. 6 is a side elevational view of the book proceeding along the conveyor and approaching the squaring station;

FIG. 7 is an end view showing the book entering the squaring station and about to be clamped by a clamping mechanism;

FIG. 8 is an end view similar to FIG. 7 but showing the clamping mechanism grasping the book from opposite sides at a location closely adjacent to the spine of the book;

FIG. 9 is a fragmentary elevation schematic view of the clamped book approaching a squaring member in the form of a roller;

FIG. 10 is a fragmentary end view illustrating the spine of the book in contact with the squaring member;

FIG. 11 is a fragmentary elevation schematic view of the clamped book approaching a squaring member in the form of an angled shoe or ramp; and

FIG. 12 is a schematic view in perspective of a stand alone finishing line including a squaring station.

### DETAILED DESCRIPTION OF THE PREFERRED EMBODIMENT

The exemplary embodiment described herein is not intended to limit the scope of the invention to the precise form or forms disclosed. The following example has been chosen and described in order to best explain the principles of the invention and its practical use in order to enable others skilled in the art to follow its teachings.

Referring now to the drawings, a saddle stitch finishing line generally referred to by the reference numeral 20 is shown and includes a squaring station 22 assembled in accordance with the teachings of the present invention. The finishing line 20 is shown in conjunction with and integrated into a saddle stitch binding line 21 having a gathering chain or gathering conveyor 24 of the type commonly employed in the art and which is movable past a plurality of packer boxes 26, 28, 30, 32, etc. The gathering conveyor 24 includes a plurality of chain spaces (not shown) of the type commonly employed in the art, each of which is adapted to gather a signature from at least one of the packer boxes 26, 28, 30, 32, in seriatim fashion. Although only four packer boxes 26, 28, 30, 32 are shown, it will be understood that the typical saddle stitch binding line 21 may include additional or fewer packer boxes depending on the size of the binding line 21 and depending on other practical considerations. As would be known, a suitable controller 23 and a user interface 25 may be provided as are commonly employed in printing operations in order to control the operation of the binding line 21 and or the delivery of the appropriate signatures from the packer boxes 26, 28, 30 and 32.

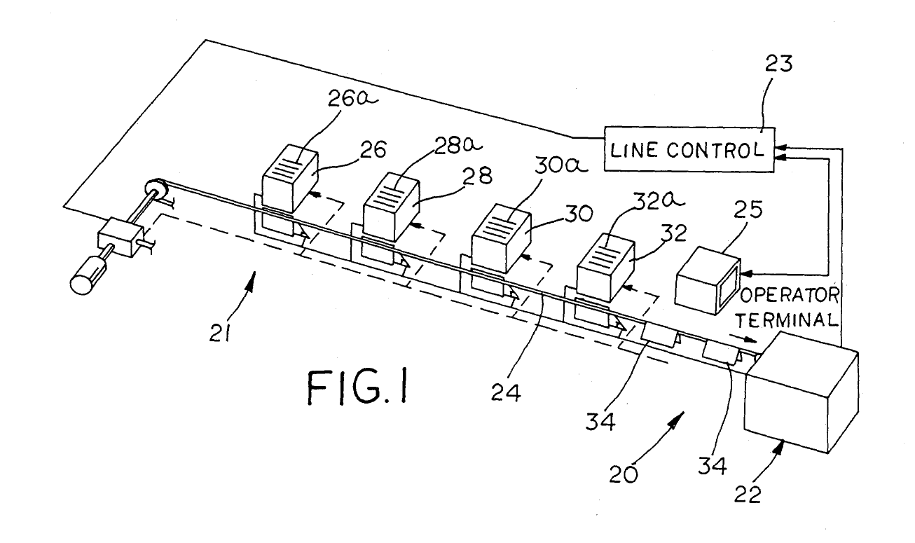

As also would be known, each of the packer boxes 26, 28, 30, 32 contains a number of signatures, e.g., signatures 26a, 28a, 30a, and 32a, respectively. Upon direction of the controller 23, one or more of the packer boxes 26, 28, 30, 32 is enabled, thereby delivering their respective signatures 26a, 28a, 30a, 32a contained in the individual packer box to the gathering conveyor 24 for assembly into a book 34. A more detailed explanation of the saddle stitch binding line 21, including a description of its operation and component parts, can be found in U.S. Pat. No. 5,458,323. However, it will be appreciated to those of skill in the art, that the actual details of the binding line may vary without departing from the spirit and scope of the invention disclosed herein. In FIG. 1, a pair of the books 34 are shown on the gathering conveyor 34 entering the finishing line 20 and prior to entering the squaring station 22. In the example of FIG. 1, the finishing line 20, including the squaring station 22, are integrated into the binding line 21.

Referring now to FIG. 2, a number of conventional prior art saddle stitch books 34 are shown. Each of the books 34 includes a generally pointed or rounded spine 36 of the type that is typically produced on a conventional saddle stitch binding line. It will be appreciated that when the plurality of books 34 are stacked as shown in FIG. 2, the generally rounded or pointed spine 36 generally causes the of books 34 to be significantly higher at the spine 36 compared to the height of the other end of the stacked books adjacent the edges of the pages.

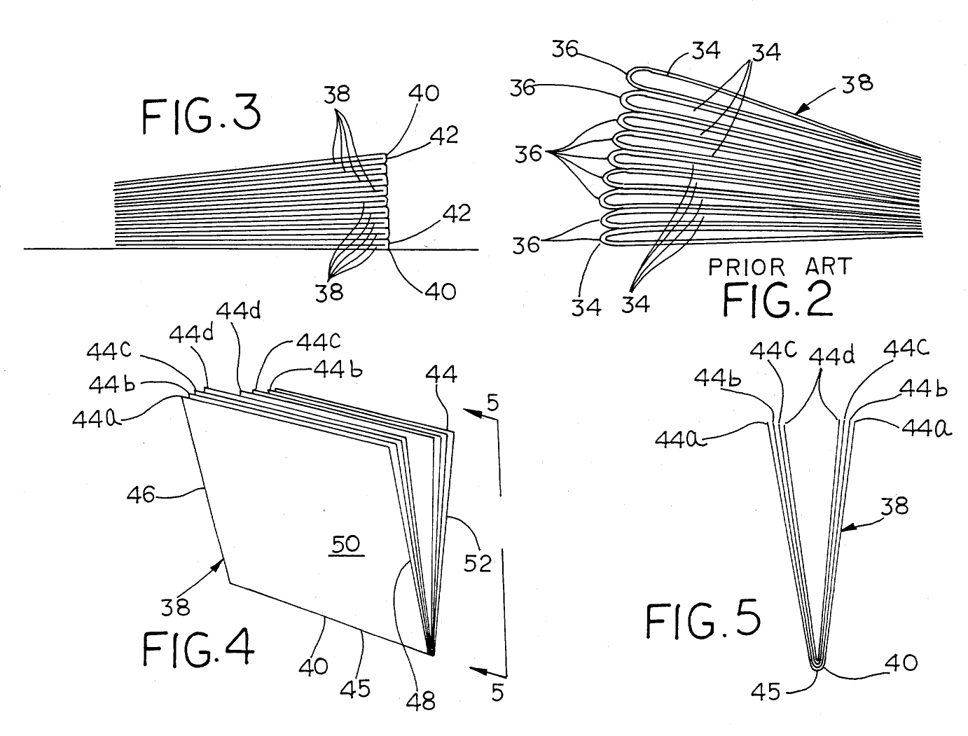

Referring now to FIG. 3, a plurality of books 38 are shown therein which have been assembled on a saddle stitch binding line 20 incorporating the squaring station 22 of the present invention. Each of the books 38 includes a spine 40. In FIGS. 4, 5, 7 and 8, the spine 40 is shown prior to the book 38 being processed in the squaring station 22. However, in FIG. 3, the spine 40 has been squared or flattened in the manner to be discussed in greater detail below so as to include having a squared or generally flat face 42. Also, although in FIGS. 4, 5, 7 and 8 the book 38 is shown in a spine-down orientation, the teachings of the present invention are equally applicable to other orientations for the book 38.

Referring now to FIG. 4, the book 38 shown therein is formed of a plurality of signatures 44a, 44b, 44c, 44d, each of which includes a fold 45, with the folds 45 being generally nested and aligned with each other so as to generally form the spine 40. It will be appreciated that each of these signatures 44a, 44b, 44c, 44d are typically formed into the book 38 on the binding line 20 by being delivered to the gathering conveyor 24 by the individual packer boxes 26, 28, 30 and 32, respectively. As shown in FIG. 4, the book 38 includes a head 46, a foot 48, a front face 50 and a rear face 52. The book 38 also includes the spine 40, which in the configuration of FIGS. 4, 5, 7 and 8 remains in the substantially pointed configuration.

Referring now to FIG. 5, the book 38 is again shown prior to reaching the squaring station 22, with the spine 36 again shown in a conventionally and generally pointed configuration. For ease of reference, the details of the gathering conveyor 24 and other components of the binding line 20 have been omitted, although those components, except for the squaring station, would be known to those of skill in the art.

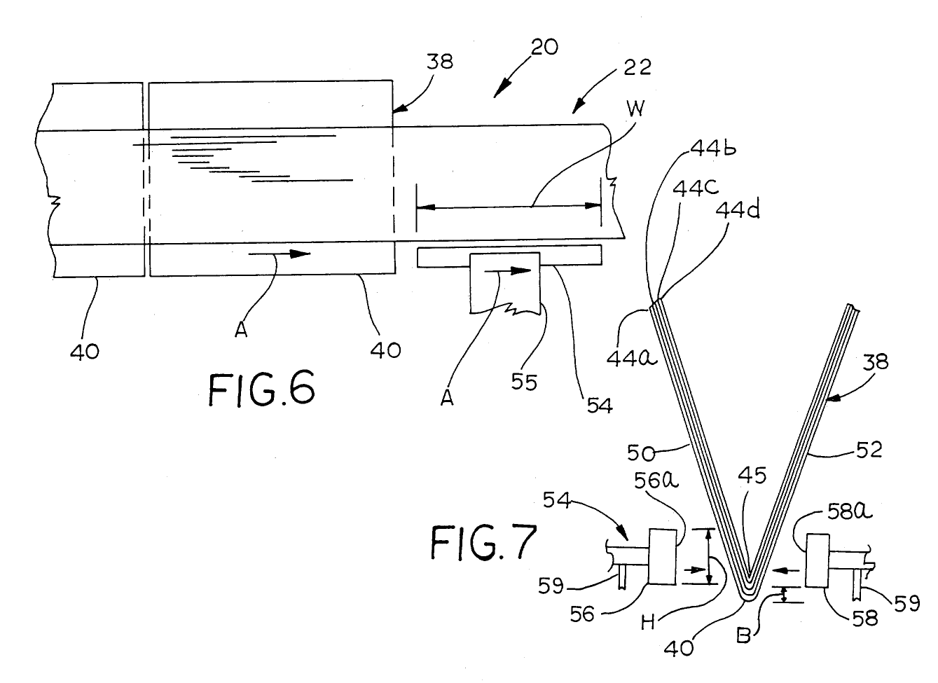

Referring now to FIG. 6, a plurality of books 38 are shown proceeding along the finishing station 20 portion of the binding line 20, and carried by the conveyor 24 in a direction indicated by the letter A. The books 38 are shown with the spine 40 disposed generally downward when viewing the figure as the books 38 approach the squaring station 22. The squaring station 22, which in the example of FIGS. 1 and 6 is preferably integrated into the binding line 20, includes a clamp mechanism 54. The clamp mechanism 54 is disposed to grasp the books 38 at a location generally adjacent to the spine 40 as will be explained in greater detail below. The clamp mechanism 54 is connected to an advancing mechanism 55, such that the clamp mechanism 54 also proceeds generally along the path A. Thus, in accordance with the disclosed example, the clamp mechanism 54 may be made to move along the path A at a speed approximating the speed at which the books 38 are advancing along the binding line 20.

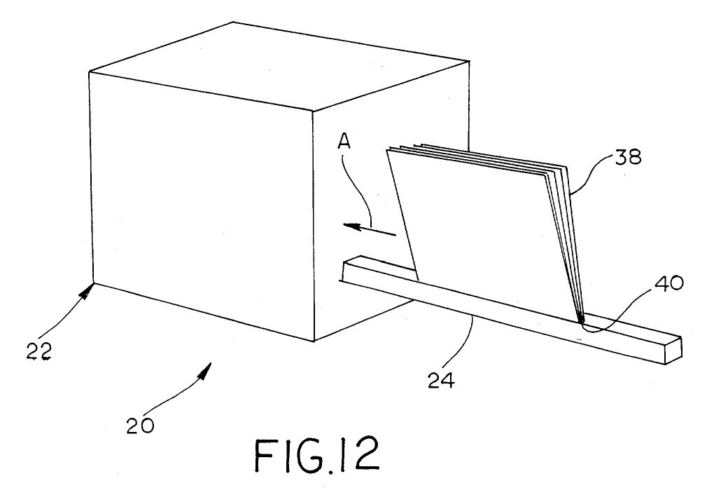

Referring now to FIG. 7, the clamp mechanism 54, in accordance with the disclosed example, includes a clamp 56 and a clamp 58, each of which includes a face 56a, 58a, respectively. The clamps 56 and 58 are disposed on opposite sides of the conveyor 24 (FIG. 1 or 12) so as to be disposed on opposite sides of the book 38. It will be noted that the clamps 56, 58 are disposed above the lower extent of the spine 40 a distance generally indicated by the reference numeral B. Preferably, this distance B may be adjusted, such as by using a suitable adjustment mechanism 59 engaging each of the clamps 56, 58. In the disclosed example the distance B is chosen to be approximately 3 mm measured from the spine 40, although this distance may vary depending on the bulk of the book and paper type.

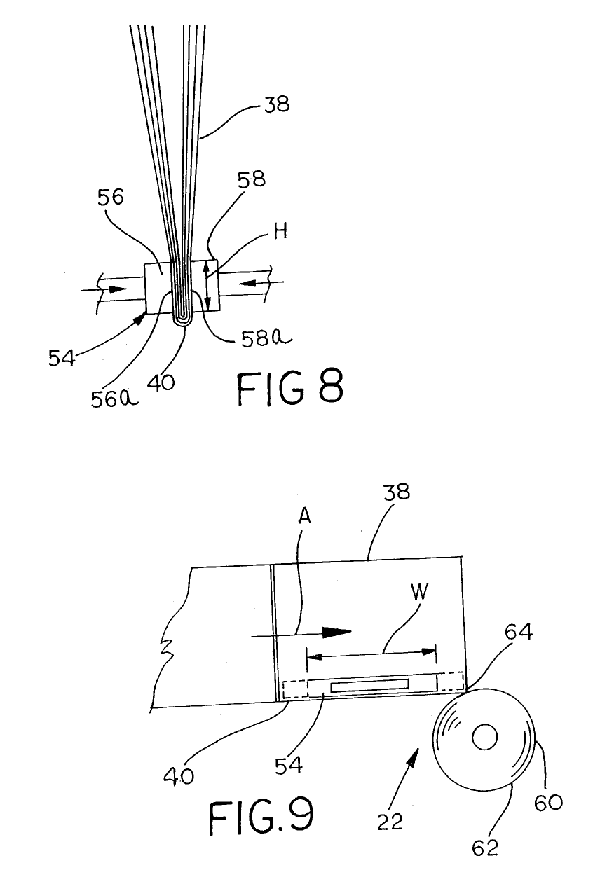

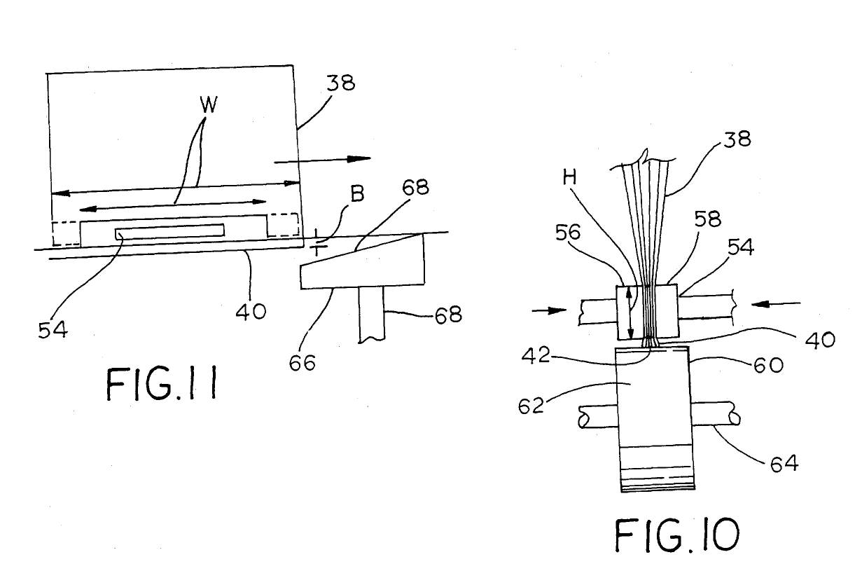

The clamps 56 and 58 will be shiftable between a position in which the clamps 56 and 58 are retracted away from the conveyor 24 (FIG. 1 or 12) and hence removed away from the front and back faces 50, 52 of the book 38. The clamps 56 and 58 will preferably generally straddle the path of the book. Using conventional actuating systems, or any other suitable system, the clamps 56 and 58 will shift between the retracted position shown in FIG. 7, and advanced position (FIG. 8) in which the faces 56a, 58a of the clamps 56, 58, respectively, make contact with the book 38 adjacent to the spine 40 as shown in FIG. 8. In the disclosed example, the faces 56a, 58a of the clamps 56, 58 may have a width W that roughly approximates the length of the spine 40 (see FIGS. 6, 9, and 11, with FIGS. 9 and 11 illustrating the width W of the clamps extended in dotted lines to roughly match the length of the spine 40).

Referring now to FIG. 8, the book 38 is shown therein with the opposing faces 50, 52 of the book shown firmly clamped or grasped by the clamping mechanism 54 with the faces 56a, 58a in contact with the front and back faces 50, 52, respectively, of the book 38. It will be noted that in this configuration, prior to the clamp mechanism 54 proceeding through the balance of the squaring station 22, that the spine 40 remains in the generally pointed or rounded configuration. In the disclosed example, the faces 56a, 58aof the clamps 56, 58 may have a height H of approximately 25 mm, however the height H may vary.

Referring now to FIG. 9, in accordance with the first disclosed example of the present invention, the squaring station 22 employs a squaring roller 60 having an outer face 62. The book 38, which is shown proceeding along the gathering conveyor 24 grasped by the advancing clamp mechanism 54, is shown with a leading edge 64 of the spine 40 beginning to make contact with the squaring roller 60.

Referring now to FIG. 10, the book 40 is shown proceeding over the squaring roller 60, with the spine 40 being smashed or generally deformed to form the squared generally flat face 42. The squaring roller 60 is mounted on a suitable bearing or pivot 64 such that the outer face 62 of the squaring roller 60 continuously smashes or otherwise deforms the spine 40 of the book 38 to form the flat face 42 as the squaring roller 60 rotates about the pivot 64. The squaring roller 60 may be a driven roller driven by any suitable drive means (not shown). Alternatively, the squaring roller 60 may be free to rotate due to the frictional forces of the spine 40 making contact with the outer face 62. Still further, the squaring roller may be completely stationary. The squared book 38 having the spine 40 with the desired flat face 42 is then carried out of the squaring station using the conveyor 24, and the clamp mechanism 54 is released at an appopriate point which may vary but which easily may be determined by the user. The book 38 preferably exits the squaring station 22 while traveling in line with the path A, but the book may also exit transversely relative to the path A if so desired.

Referring now to FIG. 11, in accordance with a second disclosed example of the squaring station 22, the squaring roller is replace with a shoe 66 having an angled squaring face 68. In the disclosed example, the shoe 66 is held in a stationary position, while the clamp mechanism 54 advances along the gathering conveyor 24 in the manner discussed above with respect to the first disclosed example.

In both of the examples discussed in detail herein, it will be appreciated that suitable adjustment may be provided for by raising and lowering the clamps 56, 58 relative to the roller 60 or shoe 66 using the adjustment mechanism 59. Alternatively, an adjustment mechanism 69 may be provided for raising or lowering the roller 60 or the shoe 66 of the squaring station 22 with respect to the gathering conveyor 24 and/or the clamp mechanism 54. Such adjustment mechanism may, as an example, permit the distance B discussed above to be adjusted depending on certain design or operational parameters, such as, for example, the thickness of the book 38, the type of paper stock being used, and other design considerations.

Referring now to FIG. 12, the finishing line 20 is shown in a stand alone configuration. The book 38 is shown proceeding along the finishing line 20 carried by the conveyor 24 into the squaring station 22 in a direction indicated by the letter A. In the example of FIG. 12, the conveyor 24 is unconnected to the conveyor of the saddle stitch binding line. The book 38 is again shown with the spine 40 disposed generally downward. The squaring station 22 includes a clamp mechanism (not shown, but which is generally similar in all respects to the clamp mechanism 54 discussed above with respect to the earlier examples, and includes an advancing mechanism such that the clamp mechanism 54 also proceeds generally along the path A. The remaining components of the stand alone finishing line 20 and the squaring station 22 may be the same or similar to those components discussed above with respect to the above-described examples.

As an alternative configuration, the squaring station 22 may employ a series of spaced tightly driven rollers which clamp the book along the length of the spine and carry the book over a shoe, ramp, or roller of the type discussed above.

Numerous modifications and alternative embodiments of the invention will be apparent to those skilled in the art in view of the forgoing descriptions. Accordingly, these descriptions are to be construed as illustrative only and are or the purpose of teaching those skilled in the art the best mode or modes presently contemplated for caring out the invention. The details of the structure or structures disclosed herein may be varied substantially without departing from the spirit of the invention, and the exclusive use of all modifications which come within the scope of the appended claims, either literally or under the doctrine of equivalents, is reserved.

What is claimed:

1. A finishing line for forming a square back saddle stitch book from a plurality of signatures, the finishing line comprising:
a conveyor arranged to receive the book in saddle stitch form and to convey the book along a path, the book having a generally pointed spine; and
a squaring station disposed along the conveyor, the squaring station including:
a clamping device arranged to clamp the book generally adjacent to the spine; and
a squaring member having a squaring face, the squaring face transitioning between a first part disposed generally away from the path toward a second part disposed generally adjacent to the path;
the clamping device and the squaring member arranged to cooperate to smash the pointed spine of the book carried by the conveyor into a generally flat back spine in response to the book proceeding through the squaring station.

2. The device of claim 1, wherein the squaring member is a roller.

3. The device of claim 2, wherein the roller is driven.

4. The device of claim 1, wherein the squaring member is an angled ramp.

5. The device of claim 1, wherein the clamping device includes a pair of members disposed on opposite sides of the book, the clamping members operatively coupled to a drive motor, the drive motor arranged to advance the clamping device at a speed approximating a speed of the conveyor.

6. The device of claim 1, wherein the clamping device comprises a plurality of rollers.

7. The device of claim 1, wherein the conveyor is arranged to deliver the book to the squaring station with the spine pointed generally downward.

8. A saddle stitch binding line for forming a square back saddle stitch book from a plurality of signatures, the binding line comprising:
a conveyor arranged to receive folded signatures such that a fold of each signature is generally aligned with a fold of an adjacent signature to form a spine, the conveyor arranged to convey the gathered signatures along a binding path;
a binding station arranged to bind the signatures together along the spine to form a saddle stitch book;
a book clamp, the book clamp a clamp member disposed on opposite sides of the path, the book clamp arranged to clamp a book proceeding along the path at a point generally adjacent to the spine; and
a squaring member having a first portion transitioning toward a second portion, the first portion disposed generally away from the path, the second portion disposed generally in the path with at least the second portion of the squaring member positioned to contact and flatten the spine of a book proceeding along the path.

9. The device of claim 8, wherein the squaring member is a roller.

10. The device of claim 9, wherein the roller is driven.

11. The device of claim 8, wherein the squaring member is a shoe oriented at an angle relative to the path.

12. The device of claim 8, wherein the book clamp is operatively coupled to a drive motor, the drive motor arranged to move the book clamp at a speed approximating a speed of the conveyor.

13. The device of claim 8, wherein the book clamp comprises a plurality of rollers.

14. The device of claim 8, wherein the squaring member is adjustable relative to the path.

15. The device of claim 8, wherein the conveyor is arranged to deliver the book to the squaring member with the spine pointed generally downward.

16. A saddle stitch finishing line for forming a square back book from a saddle stitch book, the finishing line comprising:
a conveyor arranged to receive a saddle stitch book having a pointed spine and to convey the saddle stitch book along a path;
a pair of elongated clamps straddling the path and disposed generally adjacent to the conveyor, the clamps operatively coupled to a drive system and arranged to clamp the book generally adjacent to the spine and to advance the book along the path at a desired speed; and
a squaring member having a first portion and a second portion, the first portion disposed generally away from the path, the second portion disposed generally in the path, the second portion having a generally flat face.

17. The device of claim 16, wherein the squaring member is adjustable relative to the path.

18. The device of claim 16, wherein the conveyor is arranged to deliver the book to the squaring member with the spine pointed generally downward.

19. The device of claim 16, wherein the squaring member is a roller.

20. The device of claim 16, wherein the squaring member is a shoe oriented at an angle relative to the path.

21. The device of claim 16, wherein each elongated clamp comprises a plurality of aligned and closely spaced rollers.
